(19) United States
(12) Patent Application Publication
(10) Pub. No.: US 2025/0364752 A1
(43) Pub. Date: Nov. 27, 2025

(54) CONNECTING STRUCTURE AND CONNECTOR

(71) Applicant: Bellwether Electronic (Kunshan) Co., Ltd., Jiangsu (CN)

(72) Inventor: Xiang-Biao TANG, Jiangsu (CN)

(21) Appl. No.: 18/796,297

(22) Filed: Aug. 7, 2024

(30) Foreign Application Priority Data
May 27, 2024 (CN) 202410664405.9

(51) Int. Cl. H01R 13/629; H01R 12/70

(52) U.S. Cl. CPC H01R 13/62905; H01R 12/7005

(57) ABSTRACT

A connecting structure includes a first connector and a second connector combined with the first connector. The first connector includes a first base body, a conductive part, a first conductive terminal, a cap body, and a handlebar component. The first base body includes a docking portion and a pivoting component disposed on the docking portion. The conductive part is disposed in the first base body. The conductive part includes a first conductive part and a second conductive part separated from the first conductive part. The handlebar component is pivotally connected to the first base body by the pivoting component. The second connector includes a second base body and a second conductive terminal. The second base body includes a connecting component engaged with the handlebar component. The connecting component is connected to a groove of the handlebar component.

### CROSS-REFERENCE TO RELATED APPLICATION

This application claims priority to China Application Serial Number 202410664405.9, filed May 27, 2024, which is herein incorporated by reference in its entirety.

### BACKGROUND

### Field of Invention

The present invention relates to a connecting structure and a connector.

### Description of Related Art

Generally, connectors are used to realize repeated plugging and unplugging between conductive wires and circuit boards. For instance, one connector can be disposed at a wire end, and another connector that matches the connector located at the wire end can be disposed at a circuit board end.

However, as the demand for transporting larger currents increases, the quantity of conductive terminals on the connector will increase accordingly, which will toughen the user performing plugging and unplugging of the connector between the board end and the wire end due to excessive friction. In addition, since the circuit board is usually surrounded by a housing, the design of the existing wire end connector will cause spatial interference between the wires and the housing if a distance between the circuit board and the housing is short.

Therefore, how to propose a connecting structure and a connector that can solve the aforementioned problems is one of the problems that the industry is currently eager to invest in research and development resources to solve.

### SUMMARY

In view of this, one purpose of the present disclosure is to provide a connecting structure and a connector that can solve the aforementioned problems.

In order to achieve the above objective, according to an embodiment of the present disclosure, a connecting structure includes a first connector and a second connector. The first connector is configured to be electrically connected to a plurality of conductive wires. The first connector includes a first base body, a conductive part, a plurality of first conductive terminals, and a handlebar component. The first base body includes a docking portion and a pivoting component disposed on the docking portion. The conductive part is accommodated in the first base body. The conductive part includes a first conductive part and a second conductive part separated from the first conductive part. The first conductive terminals are disposed in the first conductive part and the second conductive part. The handlebar component is pivotally connected to the first base body by the pivoting component. The second connector is disposed on a circuit board and is configured to be mated with the first connector. The second connector includes a second base body and a plurality of second conductive terminals. The second base body has a cavity configured to accommodate the docking portion of the first base body and includes a connecting component configured to be movably engaged with a groove of the handlebar component. The second conductive terminals are located in the cavity of the second base body and matches with the first conductive terminals located in the conductive part.

In one or more embodiments of the present disclosure, the first conductive part includes a first main body and a first bending portion bent from the first main body. The second conductive part includes a second main body and a second bending portion bent from the second main body. The first main body and the second main body are extended in parallel. The first bending portion and the second bending portion respectively extend away from each other from the first main body and the second main body. An extending direction of the first bending portion is perpendicular to an extending direction of the first main body. An extending direction of the second bending portion is perpendicular to an extending direction of the second main body.

In one or more embodiments of the present disclosure, the first base body has two wings laterally extending away from each other and connected to the docking portion. The first bending portion and the second bending portion are accommodated in the two wings.

In one or more embodiments of the present disclosure, the first base body further includes a partition plate located between the first conductive part and the second conductive part.

In one or more embodiments of the present disclosure, the handlebar component further includes a handlebar main body and a gripping portion connected to the handlebar main body. The groove is located on the handlebar main body.

In one or more embodiments of the present disclosure, the handlebar component further has a pivot hole located on the handlebar main body. The pivot hole is separated from the groove. The handlebar component further includes a first convex wall located in the pivot hole. The first convex wall defines a notch communicating with the pivot hole.

In one or more embodiments of the present disclosure, the pivoting component further includes a convex portion, a pivot shaft, and a characteristic extending portion. The convex portion protrudes from an outer surface of the docking portion. The pivot shaft is connected to the convex portion. The characteristic extending portion extends from a side surface of the pivot shaft and is separated from the convex portion. A shape of the pivot shaft and the characteristic extending portion conforms to a shape of the notch. The characteristic extending portion is separated from the convex portion by a distance. The first convex wall is accommodated between the characteristic extending portion and the convex portion.

In one or more embodiments of the present disclosure, the handlebar component further includes a second convex wall located in the groove. The second convex wall and the handlebar main body define an entrance located at an end of the groove.

In one or more embodiments of the present disclosure, the handlebar main body has a finger recess separated from the groove.

In one or more embodiments of the present disclosure, the connecting structure further includes a cap body. The cap body further includes a top plate and a side wall bent from the top plate. The side wall has an opening. The first base body further includes a bump engaged with the opening.

In one or more embodiments of the present disclosure, the connecting component includes a connecting pillar and a cap portion. The connecting pillar protrudes from an outer surface of the second base body. The cap portion is connected to the connecting pillar. The cap portion is separated from the second base body by a distance.

In one or more embodiments of the present disclosure, a diameter of the cap portion is greater than a diameter of the connecting pillar.

In order to achieve the above objective, according to an embodiment of the present disclosure, a connector is configured to be electrically connected to a plurality of conductive wires. The connector includes a base body, a conductive part, a plurality of conductive terminals, and a handlebar component. The base body includes a docking portion and a pivoting component disposed on the docking portion. The conductive part is accommodated in the base body. The conductive part includes a first conductive part and a second conductive part separated from the first conductive part. Each of the first conductive part and the second conductive part has a terminal hole. The conductive terminals are disposed in the terminal hole of the first conductive part and the terminal hole of the second conductive part. The handlebar component is pivotally connected to the base body by the pivoting component.

In one or more embodiments of the present disclosure, the base body has two wings laterally extending away from each other and connected to the docking portion. The two wings accommodate a portion of the first conductive part and the second conductive part.

In one or more embodiments of the present disclosure, the base body further includes a partition plate located between the first conductive part and the second conductive part.

In one or more embodiments of the present disclosure, the handlebar component further includes a handlebar main body and a gripping portion connected to the handlebar main body. The groove is located on the handlebar main body.

In one or more embodiments of the present disclosure, the handlebar component further has a pivot hole located on the handlebar main body. The pivot hole is separated from the groove. The handlebar component further includes a first convex wall located in the pivot hole. The first convex wall defines a notch communicating with the pivot hole.

In one or more embodiments of the present disclosure, the handlebar component further includes a second convex wall located in the groove. The second convex wall and the handlebar main body define an entrance located at an end of the groove.

In one or more embodiments of the present disclosure, the connector further includes a cap body. The cap body further includes a top plate and a side wall bent from the top plate. The side wall has an opening. The base body further includes a bump engaged with the opening.

In one or more embodiments of the present disclosure, each of the conductive terminals includes a bottom ring, a top ring, a connecting bridge, a top tongue portion, and a bottom tongue portion. The top ring is located over the bottom ring. The connecting bridge is connected between the bottom ring and the top ring. The top tongue portion extends from the top ring toward the bottom ring. The bottom tongue portion extends from the bottom ring toward the top ring.

In one or more embodiments of the present disclosure, an end of the top tongue portion and an end of the bottom tongue portion are suspended.

In summary, in the connecting structure and the connector of the present disclosure, since the first connector has a handlebar component that is pivotally connected to the first base body by the pivot hole, and the handlebar component is connected to connecting component of the second base body by the groove to provide a leverage, so that the handlebar component can drive the entire first base body to insert into or away from the second base body of the second connector when the user holds the gripping portion of the handlebar component, so as to achieve the effect of performing plugging and unplugging with less effort.

In the connecting structure and the connector of the present disclosure, since the first bending portion of the first conductive part and the second bending portion of the second conductive part respectively extend from the first main body and the second main body, and the first bending portion and the second bending portion extend away from each other, so that the cables connected with the first conductive part and the second conductive part do not interferes with the housing located around the circuit board, thereby achieving the effect of increasing the overall space utilization of the connecting structure in the housing. In the connecting structure and the connector of the present disclosure, since the pivot hole of the pivoting component has a notch defined by the first convex wall, and the shape of the notch matches the shape of the pivot shaft and the characteristic extending portion of the pivoting component, so that the pivot shaft and the characteristic extending portion can pass through the notch when the user installs the handlebar component to the first connector. In the connecting structure and the connector of the present disclosure, since the characteristic extending portion is separated from the convex portion, and the first convex wall is accommodated between the characteristic extending portion part and the convex portion, so that the characteristic extending portion can block the first convex wall when the user rotates the handlebar component, so as to achieve the effect of preventing the handlebar component from being detached from the first connector during the rotation.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connecting structure in accordance with an embodiment of the present disclosure;

FIG. 2 is a perspective view of a first connector in accordance with an embodiment of the present disclosure;

FIG. 3 is an exploded view of the connecting structure in accordance with an embodiment of the present disclosure;

FIG. 4 is a perspective view of a second connector in accordance with an embodiment of the present disclosure;

FIG. 5 is a top view of the second connector in accordance with an embodiment of the present disclosure;

FIG. 6 is a perspective view of a first base body in accordance with an embodiment of the present disclosure;

FIG. 7 is a top view of the first base body in accordance with an embodiment of the present disclosure;

FIG. 8 is a perspective view of a conductive part in accordance with an embodiment of the present disclosure;

FIG. 9 is a perspective view of a first conductive terminal in a second state in accordance with an embodiment of the present disclosure;

FIG. 10 is a perspective view of a handlebar component in accordance with an embodiment of the present disclosure;

FIG. 11 is a cross-sectional view of the handlebar component in accordance with an embodiment of the present disclosure;

FIG. 12 is a schematic view of the connecting structure in a first state in accordance with an embodiment of the present disclosure;

FIG. 13 is a perspective view of the connecting structure in a second state in accordance with an embodiment of the present disclosure; and

FIG. 14 is a perspective view of the connecting structure in a third state in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connecting structure CS of this embodiment and the connection relationship between the components will be described in detail.

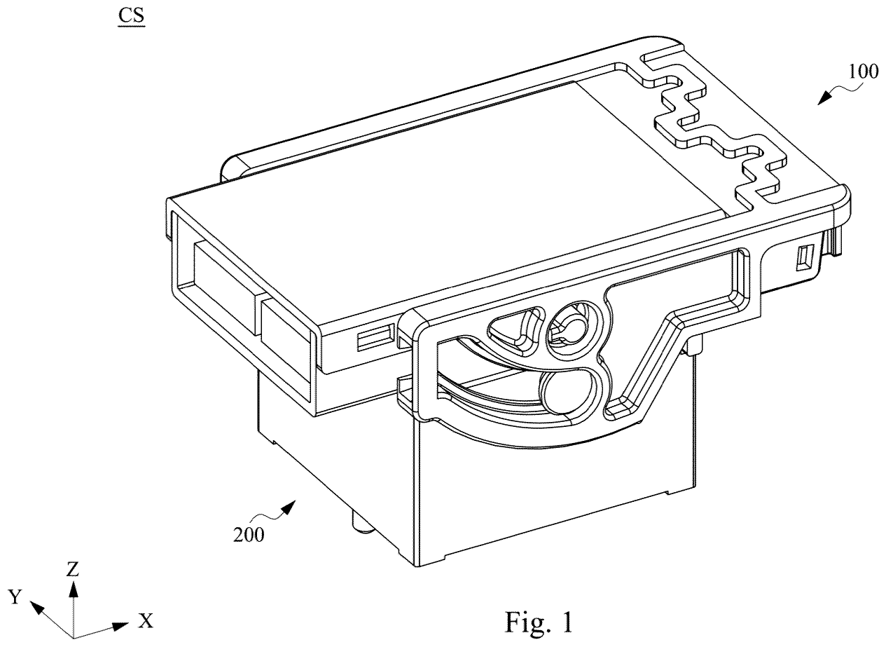

Reference is made to FIG. 1. FIG. 1 is a perspective view of a connecting structure CS in accordance with an embodiment of the present disclosure. The connecting structure CS includes a first connector 100 and a second connector 200. The second connector 200 is configured to be mated with the first connector 100. In this embodiment, the first connector 100 is configured to be electrically connected to a plurality of conductive wires (not depicted), and the second connector 200 is disposed on a circuit board (not depicted). As shown in FIG. 1, the first connector 100 moves along a mating direction (e.g., negative z-direction) to be mated with the second connector 200 and is detached from the second connector 200 along an unmating direction (e.g., positive z-direction).

In some embodiments, the first connector 100 is configured as a cable-end connector, and the second connector 200 is configured as a board-end connector. In some embodiments, the second connector 200 is relatively fixed, and the first connector 100 is movable relative to the second connector 200.

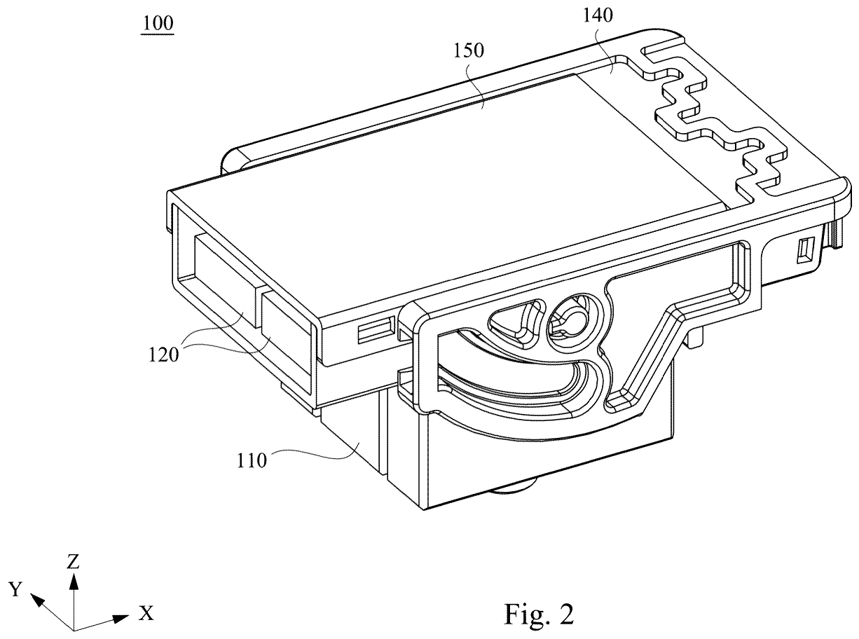

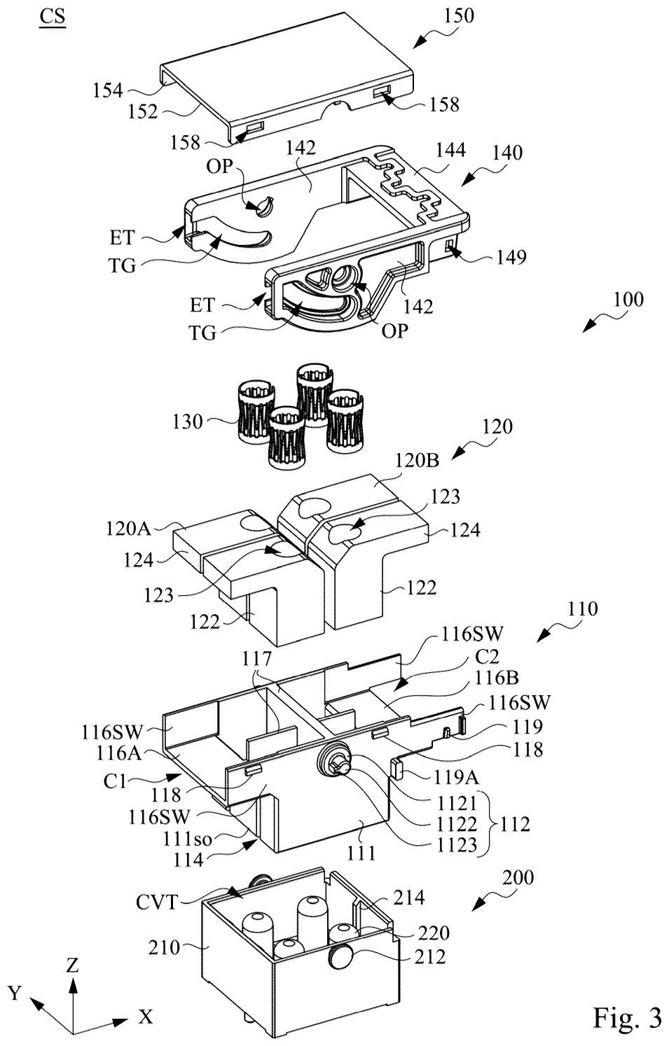

Reference is made to FIG. 2 and FIG. 3. FIG. 2 is a perspective view of the first connector 100 in accordance with an embodiment of the present disclosure. FIG. 3 is an exploded view of the first connector 100 in accordance with an embodiment of the present disclosure. As shown in FIG. 2 and FIG. 3, in this embodiment, the first connector 100 includes a first base body 110, a conductive part 120, a plurality of first conductive terminals 130, a handlebar component 140, and a cap body 150. The conductive part 120 is accommodated in the first base body 110. The cap body 150 is engaged with the first base body 110 and covers a top of the conductive part 120. Specifically, two ends of the conductive part 120 can be connected to the outside and are located in an accommodating space formed by the first base body 110 and the cap body 150. The handlebar component 140 is rotatably disposed on the first base body 110. Specifically, the handlebar component 140 is pivotally connected to the first base body 110.

In some embodiments, the first base body 110, the handlebar component 140, and the cap body 150 may be made of insulating materials. In some embodiments, the first base body 110, the handlebar component 140, and the cap body 150 may be, for example, plastic, rubber, or other suitable dielectric materials. However, the present disclosure is not intended to limit the materials of the first base body 110, the handlebar component 140, and the cap body 150.

In some embodiments, the conductive part 120 may be a conductive material. In some embodiments, the conductive part 120 may be, for example, copper or other suitable metal or conductive material. However, the present disclosure is not intended to limit the material of the conductive part 120.

Reference is made again to FIG. 3. In this embodiment, the first base body 110 includes a docking portion 111, a pivoting component 112, a plurality of limiting slots 114, an extending bottom plate 116A, an extending bottom plate 116B, an extending side plate 116SW, a partition plate 117, a plurality of bumps 118 and a positioning block 119. The second connector 200 includes a second base body 210 and a connecting component 212. The second base body 210 has a cavity CVT configured to accommodate the docking portion 111 of the first base body 110. The pivoting component 112 is disposed on the docking portion 111. The pivoting component 112 includes a convex portion 1121, a pivot shaft 1122, and a characteristic extending portion 1123. The convex portion 1121 protrudes from an outer surface 111so of first base body 110. The pivot shaft 1122 is connected to the convex portion 1121. The characteristic extending portion 1123 extends from the pivot shaft 1122.

Reference is made again to FIG. 3. The limiting slots 114 are disposed on the docking portion 111. As shown in FIG. 3, the limiting slots 114 are disposed on the outer surface 111so of the docking portion 111. The limiting slots 114 of the first base body 110 are corresponded to a plurality of limiting blocks 214 of the second base body 210.

In some embodiments, the limiting slots 114 penetrate through the docking portion 111. Specifically, the limiting slots 114 are hollowed. In some other embodiments, the limiting slots 114 are recessed from the outer surface 111so of the docking portion 111 without penetrating the docking portion 111.

Reference is made again to FIG. 3. The extending bottom plate 116A and the extending bottom plate 116B are two wings of the first base body 110, laterally extending away from each other, and connected to the docking portion 111. In some embodiments, the extending bottom plate 116A and the extending bottom plate 116B are extended in parallel. As shown in FIG. 3, specifically, the extending bottom plate 116A extends from the docking portion 111 toward the negative x-direction, and the extending bottom plate 116B extends from the docking portion 111 toward the positive x-direction. The extending side plate 116SW is vertically bent from the extending bottom plate 116A and the extending bottom plate 116B. As shown in FIG. 3, specifically, the extending side plate 116SW extends from the extending bottom plate 116A and the extending bottom plate 116B in the positive z-direction. The bumps 118 and the positioning block 119 are disposed on the extending side plate 116SW. The bumps 118 are separated from the positioning block 119. In some embodiments, the first base body 110 has a stopping block 119A for stopping an excessive rotation of the handlebar component 140. A line connecting to the stopping block 119A and the pivoting component 112 is lower than a line connecting to the positioning block 119 and the pivoting component 112.

Reference is made again to FIG. 3. The first connector 100 includes a plurality of partition plates 117 disposed in the docking portion 111. As shown in FIG. 3, specifically, one of the partition plates 117 extends on a plane extended in y-direction and z-direction, and the other one of the partition plates 117 extends on a plane extended in x-direction and z-direction.

Reference is made again to FIG. 3. In this embodiment, the conductive part 120 includes at least one first conductive part 120A and at least one second conductive part 120B that are separated from each other by the plurality of partition plates 117. The first conductive terminals 130 are disposed in the at least one first conductive part 120A and the at least one second conductive part 120B. As shown in FIG. 3, each of the at least one first conductive part 120A and the at least one second conductive part 120B includes a main body 122, a terminal hole 123, and a bending portion 124. The bending portion 124 is bent from the main body 122 and accommodated in corresponding one of the two wings of the first base body 110. The main bodies 122 of the at least one first conductive part 120A and the at least one second conductive part 120B are extended in parallel with each other. Specifically, the main body 122 of the first conductive part 120A and the main body 122 of the second conductive part 120B both extend in the z-direction. An extending direction of each of the bending portions 124 is perpendicular to an extending direction of each of the main bodies 122. The bending portion 124 of the at least one first conductive part 120A and the bending portion 124 of the at least one second conductive part 120B extend away from each other from the main body 122 of the at least one first conductive part 120A and the main body 122 of the at least one second conductive part 120B, respectively. As shown in FIG. 3, specifically, the bending portion 124 of the at least one first conductive part 120A extends from the main body 122 of the at least one first conductive part 120A toward the negative x-direction. The bending portion 124 of the at least one second conductive part 120B extends from the main body 122 of the at least one second conductive part 120B toward the positive x-direction. The terminal holes 123 of the at least one first conductive part 120A and the at least one second conductive part 120B are configured to accommodate the first conductive terminals 130. In some embodiments, the terminal holes 123 are through holes.

In some embodiments, the first conductive part 120A and the second conductive part 120B are accommodated in the first base body 110. One of the partition plates 117 is located between the first conductive part 120A and the second conductive part 120B. In other words, the second conductive part 120B is separated from the first conductive part 120A by the one of the partition plates 117. The other one of the partition plates 117 is located between the two first conductive parts 120A and between the two second conductive parts 120B. In other words, the two first conductive parts 120A are separated from each other by the above-mentioned partition plate 117, and the two second conductive parts 120B are also separated from each other by the above-mentioned partition plate 117.

In some embodiments, the first conductive part 120A and the second conductive part 120B are coupled to different voltage potentials. Each of the bending portions 124 of the first conductive part 120A and the second conductive part 120B is connected with at least one cable that exits from the first base body 110 by one of the two wings.

Reference is made again to FIG. 3. In this embodiment, the handlebar component 140 is pivotally connected to the first base body 110 by the pivoting component 112. The handlebar component 140 includes a handlebar main body 142 and a gripping portion 144. The gripping portion 144 is connected to the handlebar main body 142. The handlebar main body 142 has two side walls bent from two ends of the gripping portion 144, and each of the two side walls has a finger recess on an outer surface, separated from the groove. The gripping portion 144 is configured for a user to hold to drive the entire handlebar component 140 to rotate relative to the first base body 110. The handlebar component 140 has a pivot hole OP, a groove TG, an entrance ET, and a positioning hole 149. The pivot hole OP, the groove TG, the entrance ET, and the positioning hole 149 are located on the handlebar main body 142. The pivot hole OP is separated from the groove TG. A distance from a point on the groove TG to the pivot hole OP gradually shortens when the point moves from an end of the groove GT close to the entrance ET to the other end of the groove TG, as shown in FIG. 3. The pivoting component 112 is configured to pass through the pivot hole OP. The connecting component 212 is connected to the groove TG of the handlebar component 140. The connecting component 212 is engaged with the handlebar component 140 by the groove TG. Accordingly, the connecting component 212 moves in the groove TG. The entrance ET is located at an end of the groove TG. The connecting component 212 enters the groove TG through the entrance ET. A plurality of positioning blocks 119 of the first base body 110 are corresponded to the positioning holes 149, and the positioning blocks 119 are configured to be engaged with the positioning holes 149. The stopping blocks 119A are configured to limit the rotation of the handlebar component 140 when or after the positioning blocks 119 are engaged with the positioning holes 149.

Reference is made again to FIG. 3. In this embodiment, the cap body 150 includes a top plate 152, a side wall 154, and an opening 158. The side wall 154 is bent from the top plate 152. As shown in FIG. 3, the side wall 154 has the opening 158. The bumps 118 of the first base body 110 are corresponded to a plurality of openings 158, and the bumps 118 are configured to be engaged with the openings 158 to fix the cap body 150 with the first base body 110.

In some embodiments, the first base body 110 and the cap body 150 are combined to define a space accommodating the first conductive part 120A and the second conductive part 120B, and further define a first channel C1 accommodating the first conductive part 120A and a second channel C2 accommodating the second conductive part 120B by the partition plates 117.

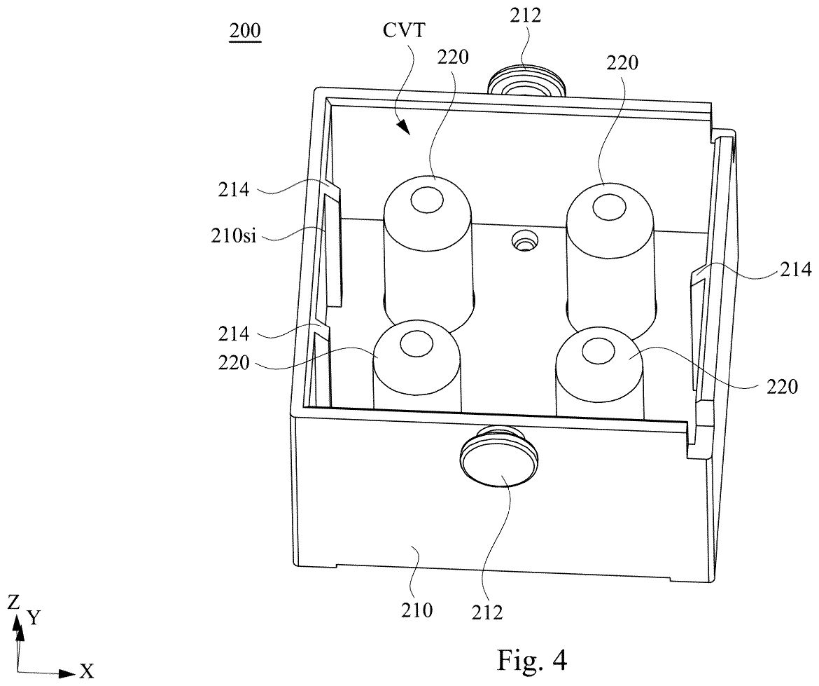

Reference is made to FIG. 4. FIG. 4 is a perspective view of the second connector 200 in accordance with an embodiment of the present disclosure. As shown in FIG. 4, in this embodiment, the second connector 200 includes a second base body 210 and a plurality of second conductive terminals 220. Each of the second conductive terminals 220 is a cylindrical plug. The second base body 210 further includes the limiting blocks 214. The limiting blocks 214 are configured to allow the first connector 100 to be limited by the second connector 200 and are disposed at a relative position on an inner surface 210si of the second connector 200 to perform a mistake proofing function. This ensures the correctness of an adaptation direction when the first base body 110 and the second base body 210 are mated with each other. As shown in FIG. 4, the limiting blocks 214 are disposed on the inner surface 210si of the second base body 210 and extend in the cavity CVT. One end of the second conductive terminals 220 are located in the cavity CVT of the second base body 210, and another end thereof passes through a bottom side of the second base body 210 to be mounted on a circuit board (not depicted). The second conductive terminals 220 are configured to match the first conductive terminals 130 located in the conductive part 120.

In some embodiments, the limiting blocks 214 are elongated in a direction (e.g., z-direction). In some embodiments, the limiting blocks 214 are arranged along another direction (e.g., x-direction or y-direction).

As shown in FIG. 4, in some embodiments, the second base body 210 includes four side plates, and at least one side plate has the limiting blocks 214 with different quantities or positions or widths. As shown in FIG. 4, for example, one of the side plates may be provided with two limiting blocks 214, and another one of the side plates opposite to the one of the side plates may be provided with one limiting block 214. However, the present disclosure is not intended to limit the quantity and the shape of the limiting blocks 214.

As shown in FIG. 4, in some embodiments, the second conductive terminals 220 are elongated in a direction (e.g., z-direction). In some embodiments, the second conductive terminals 220 are arranged along another direction (e.g., x-direction or y-direction).

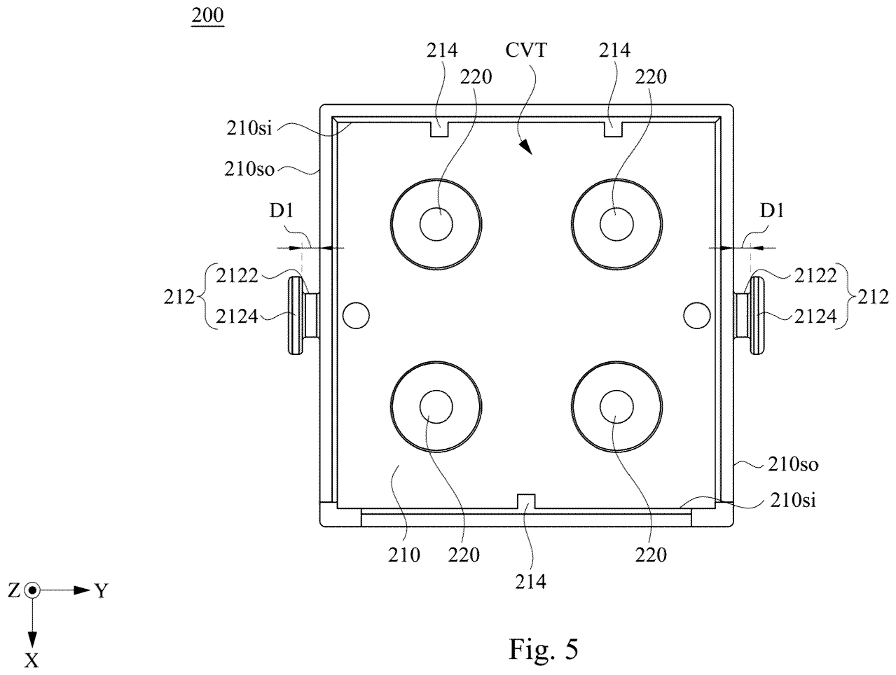

Reference is made to FIG. 5. FIG. 5 is a top view of the second base body 210 in accordance with an embodiment of the present disclosure. As shown in FIG. 5, in this embodiment, the connecting component 212 is disposed on an outer surface 210so of the second base body 210. The connecting component 212 includes a connecting pillar 2122 and a cap portion 2124. The connecting pillar 2122 protrudes from the outer surface 210so of the second base body 210. The cap portion 2124 is connected to the connecting pillar 2122. As shown in FIG. 5, the cap portion 2124 is separated from the second base body 210 by a distance D1. Specifically, the distance D1 refers to the distance between the cap portion 2124 and the outer surface 210so of the second base body 210.

As shown in FIG. 5, in some embodiments, a diameter of the cap portion 2124 is greater than a diameter of the connecting pillar 2122. Specifically, the diameter of the connecting pillar 2122 refers to the diameter of the connecting pillar 2122 extending on a plane extended in the x-direction and the z-direction, and the diameter of the cap portion 2124 refers to the diameter of the cap portion 2124 extending on a plane extended in the x-direction and the z-direction.

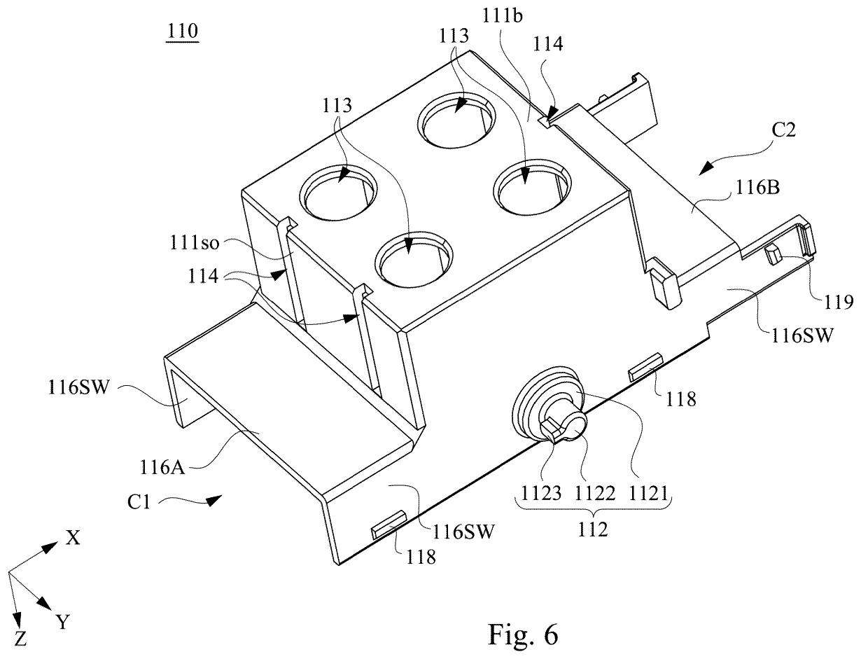

Reference is made to FIG. 6. FIG. 6 is a perspective view of the first base body 110 in accordance with an embodiment of the present disclosure. As shown in FIG. 6, in this embodiment, the first base body 110 further has a plurality of apertures 113. The apertures 113 penetrate through a bottom surface 111b of the docking portion 111. The apertures 113 are corresponded to the terminal holes 123 and the second conductive terminals 220. As shown in FIG. 6, in some embodiments, the characteristic extending portion 1123 is connected to the pivot shaft 1122 and extends parallel to the x-direction. However, the present disclosure is not intended to limit an extending direction of the characteristic extending portion 1123.

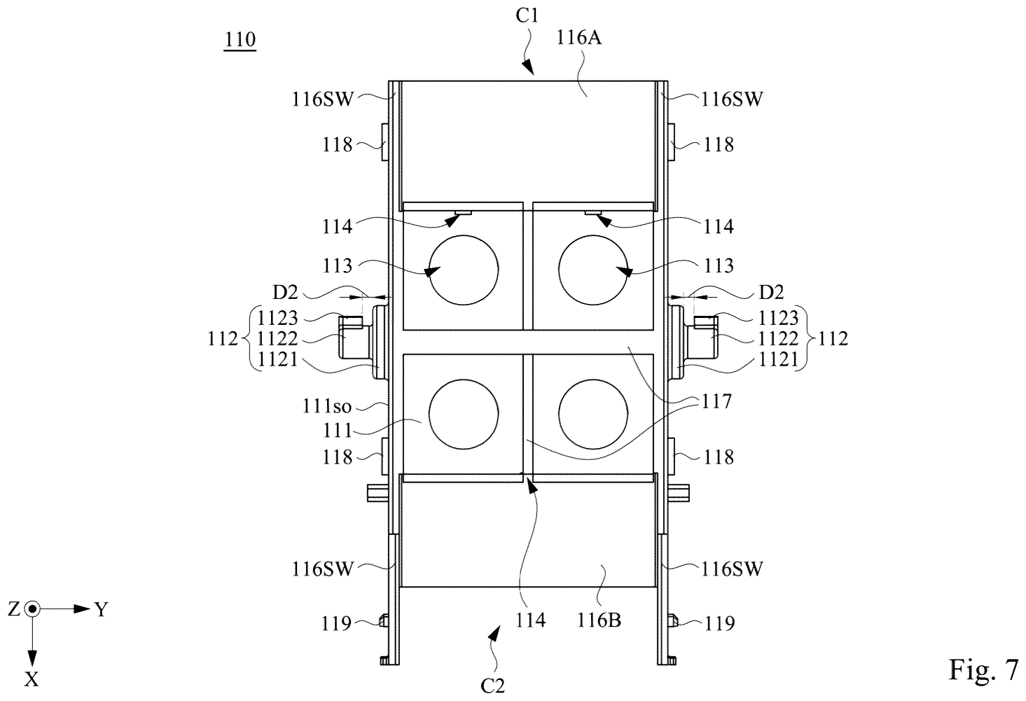

Reference is made to FIG. 7. FIG. 7 is a top view of the first base body 110 in accordance with an embodiment of the present disclosure. As shown in FIG. 7, in this embodiment, the pivot shaft 1122 protrudes from the convex portion 1121 away from the outer surface 210so of the second base body 210. The characteristic extending portion 1123 is disposed at an end of the pivot shaft 1122 away from the pivot shaft 1122. The characteristic extending portion 1123 extends from pivot shaft 1122 and is separated from the convex portion 1121. Specifically, the characteristic extending portion 1123 extends from a side surface of the pivot shaft 1122. As shown in FIG. 7, the characteristic extending portion 1123 is separated from the convex portion 1121 by a distance D2. Specifically, the distance D2 refers to the distance between the characteristic extending portion 1123 and the convex portion 1121 in the y-direction.

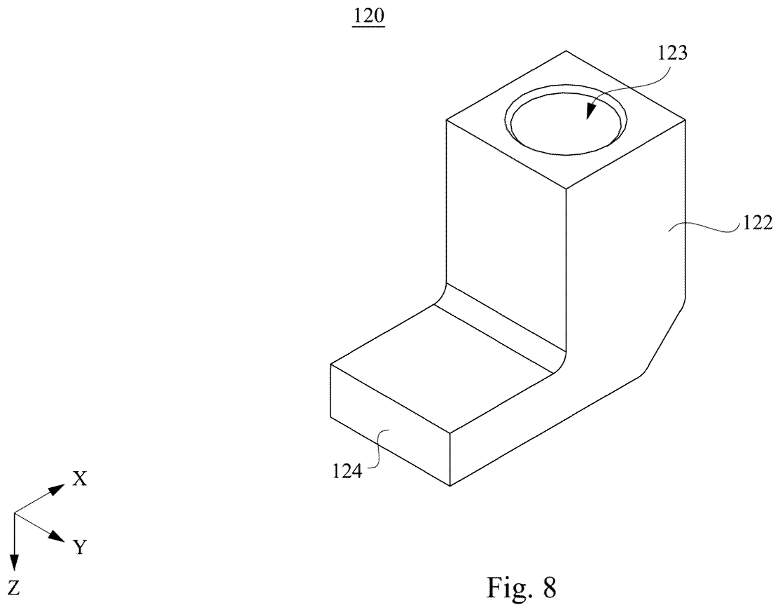

Reference is made to FIG. 8. FIG. 8 is a perspective view of the conductive part 120 in accordance with an embodiment of the present disclosure. As shown in FIG. 3 and FIG. 8, in this embodiment, the terminal holes 123 penetrate through the conductive part 120 (i.e., the first conductive part 120A or the second conductive part 120B). In some embodiments, the terminal holes 123 penetrate through portions of the main body 122 and the bending portion 124. In some embodiments, the terminal holes 123 extend along a direction (e.g., z-direction).

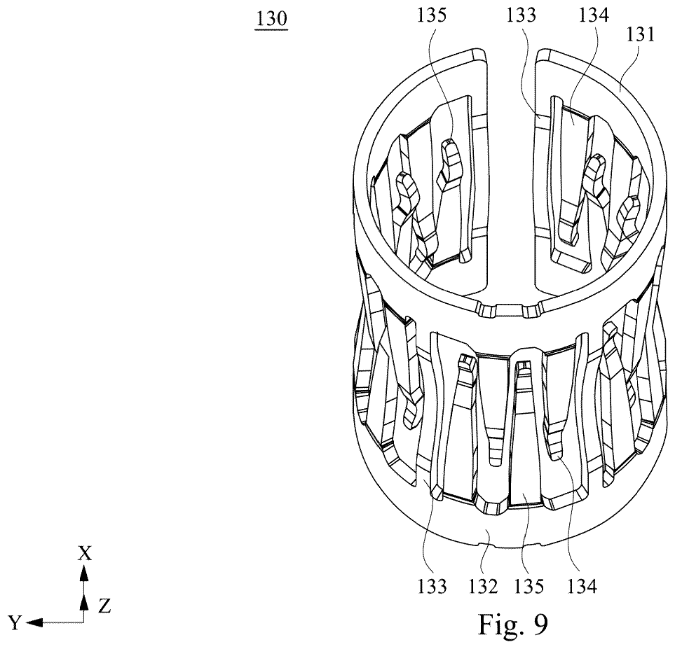

Reference is made to FIG. 9. FIG. 9 is a perspective view of the first conductive terminal 130 in accordance with an embodiment of the present disclosure. As shown in FIG. 9, in this embodiment, the first conductive terminal 130 is annular and includes a top ring 131, a bottom ring 132, a plurality of connecting bridges 133, a plurality of top tongue portions 134, and a plurality of bottom tongue portions 135. The top ring 131 is located over the bottom ring 132. The connecting bridges 133 are connected between the top ring 131 and the bottom ring 132. In some embodiments, a center of the connecting bridges 133 is bent toward the inside of the first conductive terminal 130. The top tongue portions 134 extend from the top ring 131 toward the bottom ring 132. Specifically, an end of the top tongue portions 134 is connected to the top ring 131, and the other end of the top tongue portions 134 is suspended. The bottom tongue portions 135 extend from the bottom ring 132 toward the top ring 131. Specifically, an end of the bottom tongue portions 135 is connected to the bottom ring 132, and the other end of the bottom tongue portions 135 is suspended. Since the first conductive terminal 130 further includes the plurality of top tongue portions 134 and the bottom tongue portions 135 in addition to the connecting bridges 133, a contact area between the first conductive terminals 130 and the second conductive terminals 220 can be increased when the second conductive terminals 220 pass through the conductive part 120 and contact the first conductive terminals 130, so as to meet the requirement of transmitting large current.

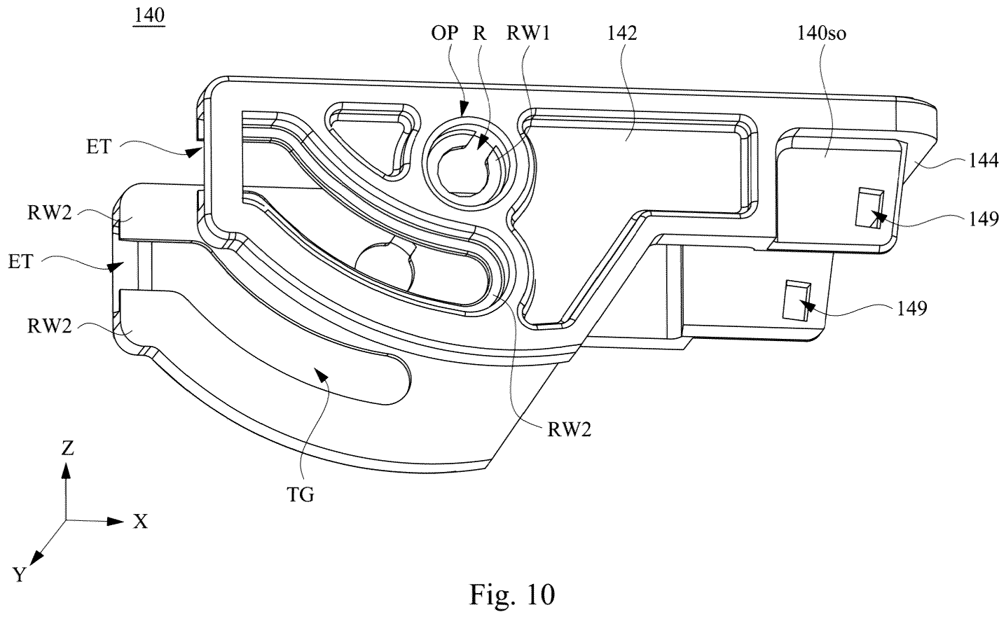

Reference is made to FIG. 10. FIG. 10 is a perspective view of the handlebar component 140 in accordance with an embodiment of the present disclosure. As shown in FIG. 10, in this embodiment, the handlebar component 140 has an outer surface 140so. The pivot hole OP, the groove TG, and the positioning hole 149 are disposed on the outer surface 140so of the handlebar component 140 and penetrate through the handlebar main body 142. As shown in FIG. 10, the handlebar component 140 further includes a first convex wall RW1. The first convex wall RW1 is located in the pivot hole OP. In some embodiments, the first convex wall RW1 extends from an inner wall of the pivot hole OP and surrounds in the pivot hole OP. In some embodiments, the first convex wall RW1 is not completely ring-shaped. As shown in FIG. 10, specifically, since the first convex wall RW1 does not form a ring by itself, the first convex wall RW1 defines the notch R. The notch R communicates with the pivot hole OP. In some embodiments, a shape of the pivot shaft 1122 and the characteristic extending portion 1123 matches a shape of the pivot hole OP and a shape of the notch R. Specifically, as shown in FIG. 6 and FIG. 10, the shape of the pivot shaft 1122 and the characteristic extending portion 1123 refer to the shape of the pivot shaft 1122 and the characteristic extending portion 1123 as viewed in the y-direction, and the shape of the pivot hole OP and the notch R refers to the shape of the pivot hole OP and the notch R as viewed in the y-direction.

Reference is made again to FIG. 10. In this embodiment, as shown in FIG. 10, the handlebar component 140 further includes a second convex wall RW2. The second convex wall RW2 is located in the groove TG. In some embodiments, the second convex wall RW2 extends from an inner wall of the groove TG and surrounds in the groove TG. In some embodiments, the second convex wall RW2 is not completely ring-shaped. As shown in FIG. 10, specifically, since the second convex wall RW2 does not form a ring by itself, the second convex wall RW2 and the handlebar main body 142 define the entrance ET at one end of the groove TG. A distance between a point in the groove TG and the pivot hole OP gradually shorten along with that the point moves from the entrance ET to another end of the groove TG.

Reference is made to FIG. 6, FIG. 7, and FIG. 10. Since the shape of the pivot shaft 1122 and the characteristic extending portion 1123 matches the shape of the pivot hole OP and the notch R, the handlebar component 140 can be combined with the pivoting component 112 by the notch R located in the pivot hole OP. When the handlebar component 140 is pivotally connected to the pivoting component 112 of the first base body 110 by the notch R, the first convex wall RW1 is accommodated between the characteristic extending portion 1123 and the convex portion 1121.

Reference is made to FIG. 4, FIG. 5, and FIG. 10. Since the second convex wall RW2 generally conforms to the groove TG, the connecting component 212 can enter the groove TG through the entrance ET of the handlebar component 140. When the connecting component 212 moves in the groove TG, the second convex wall RW2 is accommodated between the outer surface 210so of the second base body 210 and the cap portion 2124.

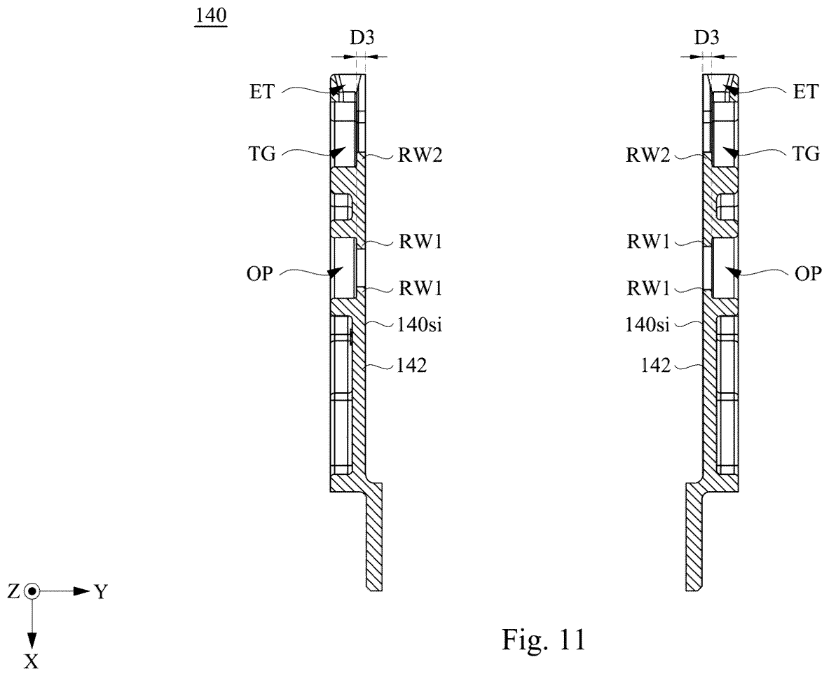

Reference is made to FIG. 11. FIG. 11 is a cross-sectional view of the handlebar component 140 in accordance with an embodiment of the present disclosure. As shown in FIG. 11, in this embodiment, the handlebar component 140 has an inner surface 140si. A surface of the first convex wall RW1 is coplanar with the inner surface 140si of the handlebar component 140. A surface of the second convex wall RW2 is coplanar with the inner surface 140si of the handlebar component 140. As shown in FIG. 11, each of the first convex wall RW1 and the second convex wall RW2 has a thickness D3. Specifically, the thickness D3 of the first convex wall RW1 and the second convex wall RW2 refers to the thickness of the first convex wall RW1 and the second convex wall RW2 in the y-direction.

Reference is made to FIG. 5 and FIG. 11. In some embodiments, the distance D1 between the cap portion 2124 and the outer surface 210so of the second base body 210 is equal to or greater than the thickness D3 of the second convex wall RW2. Since the distance D1 is equal to or greater than the thickness D3, the second convex wall RW2 is accommodated between the outer surface 210so of the second base body 210 and the cap portion 2124. Therefore, the connecting component 212 can move in the groove TG. Reference is made to FIG. 7 and FIG. 11. In some embodiments, the distance D2 between the characteristic extending portion 1123 and the convex portion 1121 is equal to or greater than the thickness D3 of the first convex wall RW1. Since the distance D2 is equal to or greater than the thickness D3, the first convex wall RW1 is accommodated between the characteristic extending portion 1123 and the convex portion 1121.

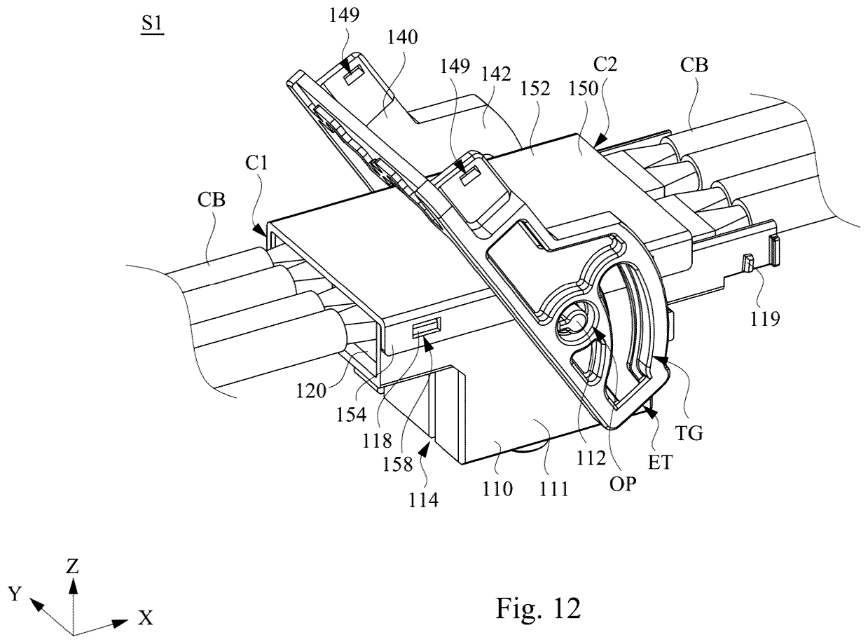

Reference is made to FIG. 12. FIG. 12 is a schematic view of the connecting structure CS in a first state S1 in accordance with an embodiment of the present disclosure. As shown in FIG. 12, in this embodiment, a plurality of cables CB are electrically connected to the conductive part 120. When the connecting structure CS is in the first state S1, the first connector 100 is combined with the handlebar component 140 by passing through the pivot hole OP by the pivot shaft 1122 and the characteristic extending portion 1123.

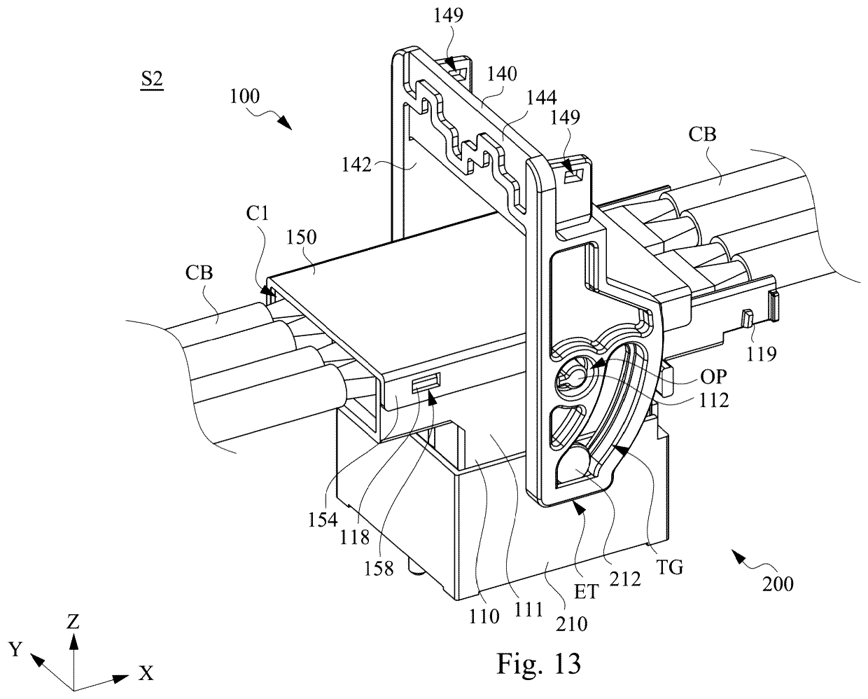

Reference is made to FIG. 13. FIG. 13 is a schematic view of the connecting structure CS in a second state S2 in accordance with an embodiment of the present disclosure. As shown in FIG. 13, in this embodiment, the connecting structure CS has the second state S2 different from the first state S1. As shown in FIG. 13, when the connecting structure CS is in the second state S2, a portion of the docking portion 111 is located in the second base body 210. The pivoting component 112 is pivotally connected to the pivot hole OP, and the connecting component 212 enters the groove TG through the entrance ET.

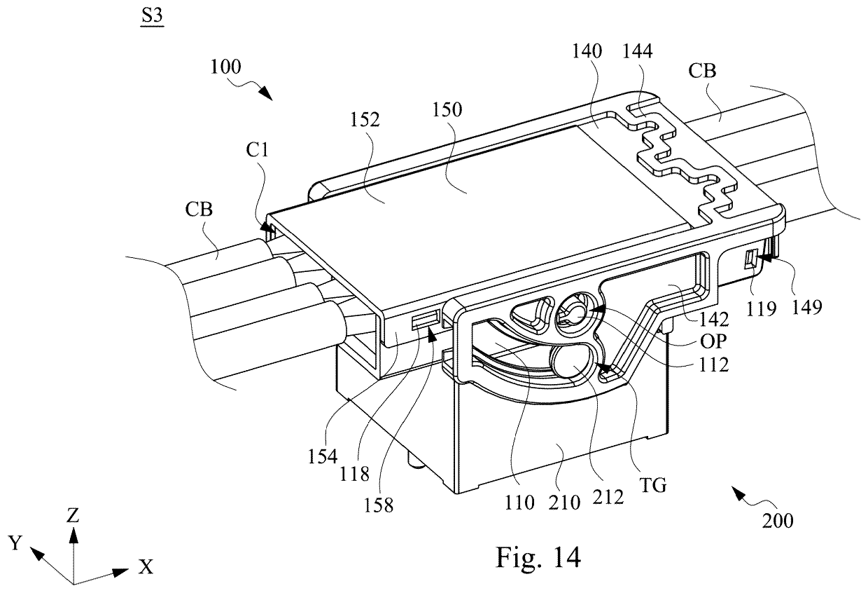

Reference is made to FIG. 14. FIG. 14 is a schematic view of the connecting structure CS in a third state S3 in accordance with an embodiment of the present disclosure. Along with the rotation of the handlebar component 140, moving away from the entrance ET to the other end of groove TG, the docking portion 111 is gradually inserted into the cavity CVT of the second base body 210 while the connecting structure CS is altered from the second state S2 into the third state. When the connecting structure CS is in the third state S3, the positioning block 119 of the first base body 110 is engaged with the positioning hole 149 of the handlebar component 140 and the gripping portion 144 of the handlebar component 140 is horizontal. Therefore, the first connector 100 is mated with the second connector 200.

The following will describe in detail how the user mates the first connector 100 with the second connector 200 and how to detach the first connector 100 from the second connector 200.

Reference is made to FIG. 12. In a usage scenario, as shown in FIG. 12, the user can firstly grip the handlebar component 140 installed in the first connector 100. Reference is made to FIG. 13 and FIG. 14. In a usage scenario, as shown in FIG. 13, when the connecting structure CS alters to the second state S2 from the first state S1, the user holds the gripping portion 144 of the handlebar component 140 to allow the handlebar component 140 to rotate relative to the first connector 100, so that the handlebar component 140 is arranged in the vertical direction (e.g., z-direction). When the user rotates the handlebar component 140, the first convex wall RW1 in the pivot hole OP is accommodated between the characteristic extending portion 1123 and the convex portion 1121 (as shown in FIG. 5 and FIG. 11) to prevent the handlebar component 140 from being detached from the first connector 100. Next, the user moves the first connector 100 toward the second connector 200, so that the connecting component 212 enters the groove TG through the entrance ET. Next, as shown in FIG. 14, when the connecting structure CS alters to the third state S3 from the second state S2, the user continues to rotate the handlebar component 140, so that the connecting component 212 moves to the end of the groove TG away from the entrance ET while the docking portion 111 is gradually inserted into the cavity CVT of the second base body 210. Finally, the docking portion 111 is completely inserted into the cavity CVT of the second base body 210 and the positioning block 119 of the first base body 110 is engaged with the positioning hole 149 of the handlebar component 140. Accordingly, the first connector 100 is mated with the second connector 200.

Reference is made again to FIG. 12 to FIG. 14. In a usage scenario, as shown in FIG. 13 and FIG. 14, when the connecting structure CS alters to the second state S2 from the third state S3, the user holds the gripping portion 144 of the handlebar component 140 or the finger recesses of the two side walls of the handlebar main body 142 to allow the handlebar component 140 to rotate relative to the first connector 100. When the user rotates the handlebar component 140, the connecting component 212 moves to an end of the groove TG close to the entrance ET while the docking portion 111 is gradually departed from the cavity CVT of the second base body 210. Next, as shown in FIG. 12, when the connecting structure CS alters to the first state S1 from the second state S2, the user moves the first connector 100 in a direction away from the second connector 200, so that the connecting component 212 is detached from the groove TG through the entrance ET and the docking portion 111 of the first base body 110 is detached from the cavity CVT of the second base body 210. Accordingly, the first connector 100 is detached from the second connector 200.

In some embodiments, if the user attempts to retain the connecting structure CS in the third state S3, the user can make the positioning holes 149 of the handlebar component 140 are engaged with the positioning blocks 119 of the first base body 110.

From the above detailed description of the specific embodiments of the present disclosure, it can be clearly seen that in the connecting structure and the connector of the present disclosure, since the first connector has a handlebar component that is pivotally connected to the first base body by the pivot hole, and the handlebar component is connected to connecting component of the second base body by the groove to provide a leverage, so that the handlebar component can drive the entire first base body to insert into or away from the second base body of the second connector when the user holds the gripping portion of the handlebar component, so as to achieve the effect of performing plugging and unplugging with less effort. In the connecting structure and the connector of the present disclosure, since the first bending portion of the first conductive part and the second bending portion of the second conductive part respectively extend from the first main body and the second main body, and the first bending portion and the second bending portion extend away from each other, so that the cables connected with the first conductive part and the second conductive part do not interferes with the housing located around the circuit board, thereby achieving the effect of increasing the overall space utilization of the connecting structure in the housing. In the connecting structure and the connector of the present disclosure, since the pivot hole of the pivoting component has a notch defined by the first convex wall, and the shape of the notch matches the shape of the pivot shaft and the characteristic extending portion of the pivoting component, so that the pivot shaft and the characteristic extending portion can pass through the notch when the user installs the handlebar component to the first connector. In the connecting structure and the connector of the present disclosure, since the characteristic extending portion is separated from the convex portion, and the first convex wall is accommodated between the characteristic extending portion part and the convex portion, so that the characteristic extending portion can block the first convex wall when the user rotates the handlebar component, so as to achieve the effect of preventing the handlebar component from being detached from the first connector during the rotation.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connecting structure, comprising:
a first connector configured to be electrically connected to a plurality of conductive wires, comprising:
a first base body comprising a docking portion and a pivoting component disposed on the docking portion;
a conductive part accommodated in the first base body, the conductive part comprising a first conductive part and a second conductive part separated from the first conductive part;
a plurality of first conductive terminals disposed in the first conductive part and the second conductive part; and
a handlebar component pivotally connected to the first base body by the pivoting component; and
a second connector disposed on a circuit board and configured to be mated with the first connector, comprising:
a second base body having a cavity configured to accommodate the docking portion of the first base body and including a connecting component configured to be movably engaged with a groove of the handlebar component; and
a plurality of second conductive terminals located in the cavity of the second base body and matching with the first conductive terminals located in the conductive part.

2. The connecting structure of claim 1, wherein the first conductive part comprises a first main body and a first bending portion bent from the first main body, the second conductive part comprises a second main body and a second bending portion bent from the second main body, the first main body and the second main body are extended in parallel, the first bending portion and the second bending portion respectively extend away from each other from the first main body and the second main body, an extending direction of the first bending portion is perpendicular to an extending direction of the first main body, and an extending direction of the second bending portion is perpendicular to an extending direction of the second main body.

3. The connecting structure of claim 2, wherein the first base body has two wings laterally extending away from each other and connected to the docking portion, the first bending portion and the second bending portion are accommodated in the two wings.

4. The connecting structure of claim 1, wherein the first base body further comprises a partition plate located between the first conductive part and the second conductive part.

5. The connecting structure of claim 1, wherein the handlebar component further comprises a handlebar main body and a gripping portion connected to the handlebar main body, and the groove is located on the handlebar main body.

6. The connecting structure of claim 5, wherein the handlebar component further has a pivot hole located on the handlebar main body, and the pivot hole is separated from the groove, wherein the handlebar component further comprises a first convex wall located in the pivot hole, and the first convex wall defines a notch communicating with the pivot hole.

7. The connecting structure of claim 6, wherein the pivoting component further comprises:
a convex portion protruding from an outer surface of the docking portion;
a pivot shaft connected to the convex portion; and
a characteristic extending portion extending from a side surface of the pivot shaft and separated from the convex portion, and a shape of the pivot shaft and the characteristic extending portion conforming to a shape of the notch, wherein the characteristic extending portion is separated from the convex portion by a distance, and the first convex wall is accommodated between the characteristic extending portion and the convex portion.

8. The connecting structure of claim 6, wherein the handlebar component further comprises a second convex wall located in the groove, and the second convex wall and the handlebar main body define an entrance located at an end of the groove.

9. The connecting structure of claim 5, wherein the handlebar main body has a finger recess separated from the groove.

10. The connecting structure of claim 1, further comprising a cap body, wherein the cap body further comprises a top plate and a side wall bent from the top plate, the side wall having an opening, and the first base body further comprises a bump engaged with the opening.

11. The connecting structure of claim 1, wherein the connecting component comprises:
a connecting pillar protruding from an outer surface of the second base body; and
a cap portion connected to the connecting pillar, and the cap portion being separated from the second base body by a distance.

12. The connecting structure of claim 11, wherein a diameter of the cap portion is greater than a diameter of the connecting pillar.

13. A connector configured to be electrically connected to a plurality of conductive wires, comprising:
a base body comprising a docking portion and a pivoting component disposed on the docking portion;
a conductive part accommodated in the base body, the conductive part comprising a first conductive part and a second conductive part separated from the first conductive part, wherein each of the first conductive part and the second conductive part has a terminal hole;
a plurality of conductive terminals disposed in the terminal hole of the first conductive part and the terminal hole of the second conductive part; and
a handlebar component pivotally connected to the base body by the pivoting component.

14. The connector of claim 13, wherein the base body has two wings laterally extending away from each other and connected to the docking portion, and the two wings accommodate a portion of the first conductive part and the second conductive part.

15. The connector of claim 13, wherein the base body further comprises a partition plate located between the first conductive part and the second conductive part.

16. The connector of claim 13, wherein the handlebar component further comprises a handlebar main body and a gripping portion connected to the handlebar main body, a groove is located on the handlebar main body, and a pivot hole located on the handlebar main body, wherein the pivot hole is separated from the groove, and the handlebar component further comprises a first convex wall located in the pivot hole, and the first convex wall defines a notch communicating with the pivot hole.

17. The connector of claim 16, wherein the handlebar component further comprises a second convex wall located in the groove, and the second convex wall and the handlebar main body define an entrance located at an end of the groove.

18. The connector of claim 13, further comprising a cap body, wherein the cap body further comprises a top plate and a side wall bent from the top plate, the side wall having an opening, and the base body further comprises a bump engaged with the opening.

19. The connector of claim 13, wherein each of the conductive terminals comprises:
a bottom ring;
a top ring located over the bottom ring;
a connecting bridge connected between the bottom ring and the top ring;
a top tongue portion extending from the top ring toward the bottom ring; and
a bottom tongue portion extending from the bottom ring toward the top ring.

20. The connector of claim 19, wherein an end of the top tongue portion and an end of the bottom tongue portion are suspended.
